(19) United States
(12) Patent Application Publication
(10) Pub. No.: US 2009/0015851 A1
(43) Pub. Date: Jan. 15, 2009

(54) Color calibration system

(75) Inventors: Ryuta Yamaguchi, Kawasaki-shi (JP); Noriyuki Matsushima, Edogawa-ku (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/071,771

(22) Filed: Feb. 26, 2008

(30) Foreign Application Priority Data
Jul. 12, 2007 (JP) 2007-183173

(51) Int. Cl. H04N 1/46

(52) U.S. Cl. 358/1.9; 358/504

(57) ABSTRACT

Disclosed a color calibration system including: a first printing system; and a second printing system, wherein a first image processing apparatus includes: a controller to control the first printing apparatus, to obtain first measurement result data, and to calculate first differential data which is a difference between the first measurement result data and ideal value data; and a transmitting section, and a second image processing apparatus includes: a receiving section; and a controller to control the second printing apparatus, to obtain second measurement result data, to add the ideal value data and the first differential data to calculate target value data, to calculate second differential data which is a difference between the calculated target value data and the second measurement result data, and to calibrate a color conversion processing condition in the second image processing apparatus on the basis of the second differential data.

### CROSS-REFERENCE TO RELATED APPLICATION

The present U.S. patent application claims a priority under the Paris Convention of Japanese patent application No. 2007-183173 filed on Jul. 12, 2007, which shall be a basis of correction of an incorrect translation.

### BACKGROUND

1. Field of the Invention

The present invention relates to a color calibration system.

2. Description of Related Art

In order to establish color matching among printing apparatuses of plural printing systems which are set at places being remote from one another, color is adjusted so as to consist with a target value set as standard color in advance. However, in the printing system of each place, it is necessary to adjust the corresponding printing apparatus, and thus when color stability of each printing apparatus is low, errors of the respective printing apparatuses are accumulated, so that color reproducing characteristics thereof may be greatly displaced from one another.

On the other hand, with respect to printing in a closed system such as the same company or the like, it is unnecessary to match color of each printing apparatus with standard color (common target value), and it is merely necessary that the printing colors of the respective printing apparatuses are matched with one another. Furthermore, this simple adjustment is often sufficient even in an industrial printing field such as POD (Print On Demand) or the like.

For example, in order to prevent color shift occurring among plural color printing machines, there has been proposed a color calibration method of correcting image data printed by another printing machine so that the brightness of each primary color consists with the output of a reference printing machine (see Japanese Patent Application Laid-Open Publication No. 2000-50094, hereinafter referred to as “Patent Document 1”). According to this method, the maximum density of each printing machine is first adjusted, and image data are calibrated so that the brightness of each primary color every predetermined gradation consists with the corresponding gradation of the reference printing machine.

However, the color adjustment among the printing machines in the same printing system as described in the Patent Document 1 is based on the assumption that the same kind of color material such as ink, toner or the like of respective colors such as cyan, magenta, yellow, black, etc. is used in the printing machines, so that it is possible to establish the color matching by adjusting only the brightness every color of each color material. However, when printing apparatuses as color matching targets use different kinds of color materials, color is subtly different among the printing apparatuses when the color materials are magenta, for example, so that it is difficult to establish color matching by using a technique described in Patent Document 1.

### SUMMARY

The present invention was made in consideration of the above problems, and it is a major object of the present invention to easily establish color matching among plural printing systems.

To achieve at least one of the above objects, a color calibration system reflecting one aspect of the present invention includes: a first printing system having a first image processing apparatus to execute image processing containing color conversion processing on print data, a first printing apparatus and a first colorimeter; and a second printing system having a second image processing apparatus to execute image processing containing color conversion processing on print data, a second printing apparatus and a second colorimeter, wherein the first printing system and the second printing system are connected to each other through a communication network, wherein the first image processing apparatus includes: a controller to control the first printing apparatus to print a calibration image on the basis of print data of a calibration image, to obtain first measurement result data that is obtained by measuring the calibration image printed with the first printing apparatus by the first colorimeter and represented by a device independent color specification system, and to calculate first differential data which is a difference between the first measurement result data and ideal value data which is an ideal value of the color of the calibration image represented by the machine independent color specification system; and a transmitting section to transmit to the second image processing apparatus at least the first differential data out of the print data of the calibration image, the ideal value data and the first differential data, and wherein the second image processing apparatus includes: a receiving section to receive at least the first differential data out of the print data of the calibration image, the ideal value data and the first differential data from the first image processing apparatus; and a controller to control the second printing apparatus to print a calibration image on the basis of the print data of the calibration image, to obtain second measurement result data that is obtained by measuring the calibration image printed with the second printing apparatus by the second colorimeter and represented by the machine independent color specification system, to add the ideal value data and the first differential data to calculate target value data, to calculate second differential data which is a difference between the calculated target value data and the second measurement result data, and to calibrate a color conversion processing condition in the second image processing apparatus on the basis of the second differential data.

Preferably, the first image processing apparatus further comprises a storage section to store the print data of the calibration image and the ideal value data which is the ideal value of a color corresponding to the calibration image represented by the machine independent color specification system.

Preferably, the machine independent color specification system is an L*a*b* color specification system.

Preferably, the controller of the second image processing apparatus calibrates the color conversion processing condition by calibrating a color data conversion lookup table.

Preferably, the color data conversion lookup table is a lookup table to convert a color specification system used for print data to a color specification system of color materials used in the second printing apparatus.

Moreover, a color calibration system reflecting one aspect of the present invention includes: a first printing system having a first image processing apparatus to execute image processing containing color conversion processing on print data, a first printing apparatus and a first calorimeter; and a second printing system having a second image processing apparatus to execute image processing containing color conversion processing on print data, a second printing apparatus and a second calorimeter, wherein the first printing system and the second printing system are connected to each other through a communication network, wherein the first image processing apparatus includes: a controller to control the first printing apparatus to print a calibration image on the basis of print data of a calibration image, and to obtain first measurement result data that is obtained by measuring the calibration image printed with the first printing apparatus by the first calorimeter and represented by a machine independent color specification system; and a transmitting section to transmit to the second image processing apparatus at least the first measurement result data out of the print data of the calibration image and the first measurement result data, and wherein the second image processing apparatus includes: a receiving section to receive at least the first measurement result data out of the print data of the calibration image and the first measurement result data; and a controller to control the second printing apparatus to print a calibration image on the basis of the print data of the calibration image, to obtain second measurement result data that is obtained by measuring the calibration image printed with the second printing apparatus by the second colorimeter and represented by the machine independent color specification system, to calculate differential data which is a difference between the first measurement result data and the second measurement result data, and to calibrate a color conversion processing condition in the second image processing apparatus on the basis of the differential data.

Preferably, the first image processing apparatus further comprises a storage section to store the print data of the calibration image.

Preferably, the machine independent color specification is an L*a*b* color specification system.

Preferably, the controller of the second image processing apparatus calibrates the color conversion processing condition by calibrating a color data conversion lookup table.

Preferably, the color data conversion lookup table is a lookup table for converting a color specification system used for print data to a color specification system of color materials used in the second printing apparatus.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein:

FIG. 1 is a diagram showing the system construction of a color calibration system according to a first embodiment of the present invention;

FIG. 2 is a block diagram showing the construction of a controller of a local-side system;

FIG. 3A is a diagram showing an example of ideal value data;

FIG. 3B is a diagram showing an example of first measurement result data;

FIG. 3C is a diagram showing an example of first differential data;

FIG. 4 is a block diagram showing the construction of a controller of a remote-side system;

FIG. 5A is a diagram showing an example of target value data;

FIG. 5B is a diagram showing an example of second measurement result data;

FIG. 5C is a diagram showing an example of a differential profile;

FIG. 6 is a flowchart showing first reference data generating processing executed by a controller of the local-side system in the first embodiment;

FIG. 7 is a flowchart showing first calibration processing executed by the controller of the remote-side system in the first embodiment;

FIG. 8 is a flowchart showing second reference data generating processing executed by the controller of the local-side system in a second embodiment; and

FIG. 9 is a flowchart showing second calibration processing executed by the controller of the remote-side system in the second embodiment.

### DETAILED DESCRIPTION OF THE PREFERRED EMBODIMENT

### First Embodiment

First, a color calibration system according to a first embodiment of the present invention will be described.

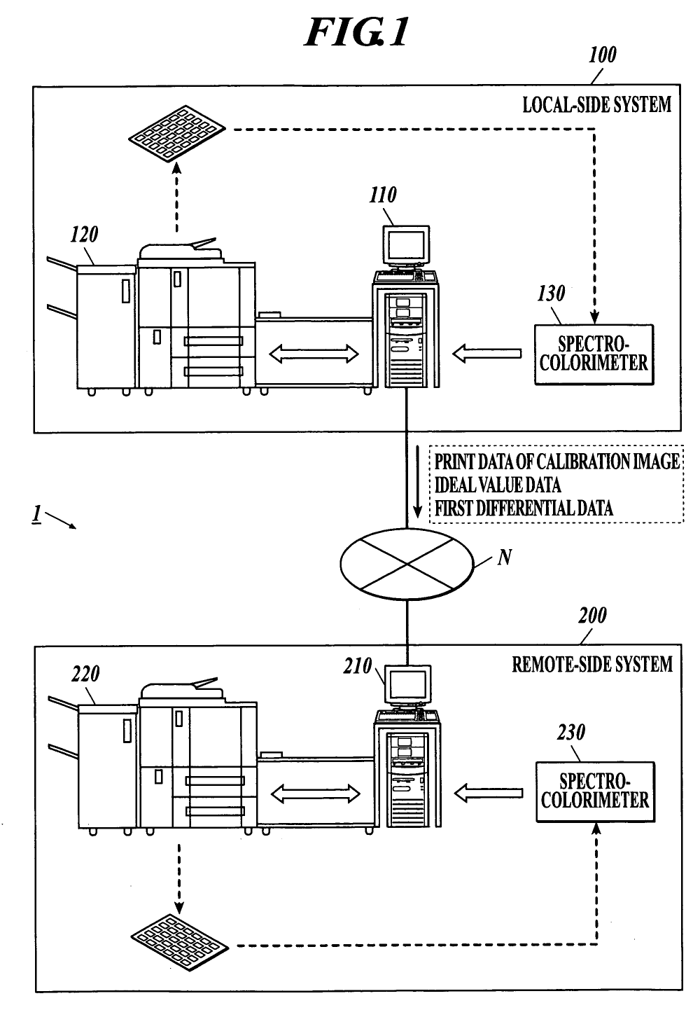

FIG. 1 is a diagram showing the construction of the color calibration system 1.

As shown in FIG. 1, the color calibration system 1 comprises a local-side system 100 as a first printing system and a remote-side system 200 as a second printing system which are connected to each other through a communication network N. In the color calibration system 1, color printed in the local-side system 100 is set as a reference, and color printed in the remote-side system 200 is calibrated so as to be matched with the color printed in the local-side system 100.

The local-side system 100 is equipped with a controller 110 as a first image processing apparatus, MFP (Multi Function Peripheral) 120 as a first printing apparatus, and a spectrocolorimeter 130. The controller 110 and MFP 120 are connected to each other so that data communication can be performed therebetween. Furthermore, the spectrocolorimeter 130 can be connected to the controller 110, and the controller 110 can obtain data of a measurement result from the spectrocolorimeter 130 when connected to the spectrocolorimeter 130.

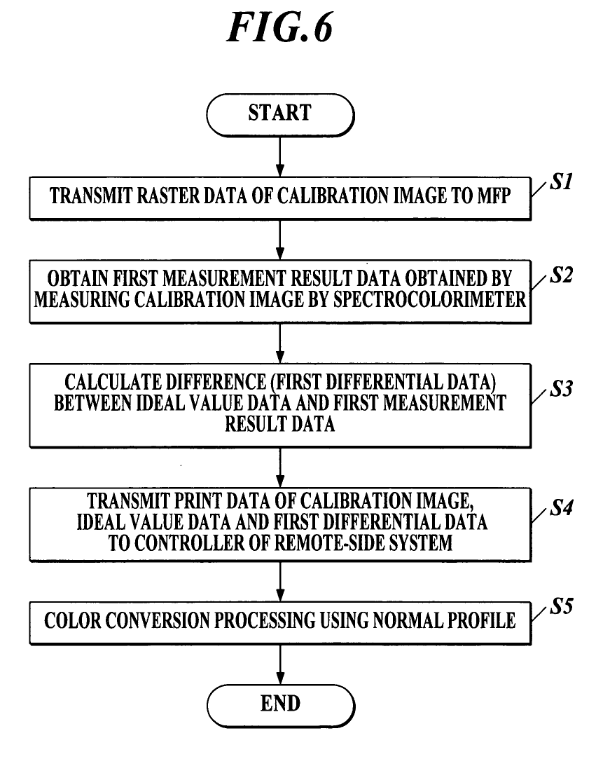

The controller 110 executes image processing containing color conversion processing on print data to generate raster data which can be printed by MFP 120. Particularly, during the first reference data generation processing (see FIG. 6), the controller 110 outputs the raster data based on the print data of a calibration image to MFP 120, and makes MFP 120 print the calibration image. The calibration image is an image containing plural patches whose input values are stepwise varied for each of colors such as cyan (C), magenta (M), yellow (Y) and black (K), and it is used to check the color reproduction characteristic of MFP 120.

MFP 120 carries out printing on a recording medium such as a sheet or the like on the basis of raster data generated by the controller 110. Particularly, when the first reference data generating processing is executed, MFP 120 prints a calibration image. Furthermore, MFP 120 has not only a printing function, but also a copying function, a scanner function and a FAX transmitting/receiving function.

The spectrocolorimeter 130 spectroscopically measures the color of each patch of the calibration image printed by MFP 120. Specifically, first measurement result data in which color of each patch is represented by the L*a*b* color specification system are obtained.

The controller 110 obtains the first measurement result data measured by the spectrocolorimeter 130, and calculates the first differential data between the ideal value data indicating the ideal value of the color corresponding to the calibration image and the first measurement result data. Then, the controller 110 transmits the print data for the calibration image, the ideal value data and the first differential data to the controller 210 of the remote-side system 200.

The remote-side system 200 is equipped with a controller 210 as a second image processing apparatus, MFP 220 as a second printing apparatus and a spectrocolorimeter 230. The controller 210 and MFP 220 are connected to each other so that data communication can be performed therebetween. Furthermore, the spectrocolorimeter 230 can be connected to the controller 210, and the controller 210 can obtain the measurement result data from the spectrocolorimeter 230 when the spectrocolorimeter 230 and the controller 210 are connected to each other.

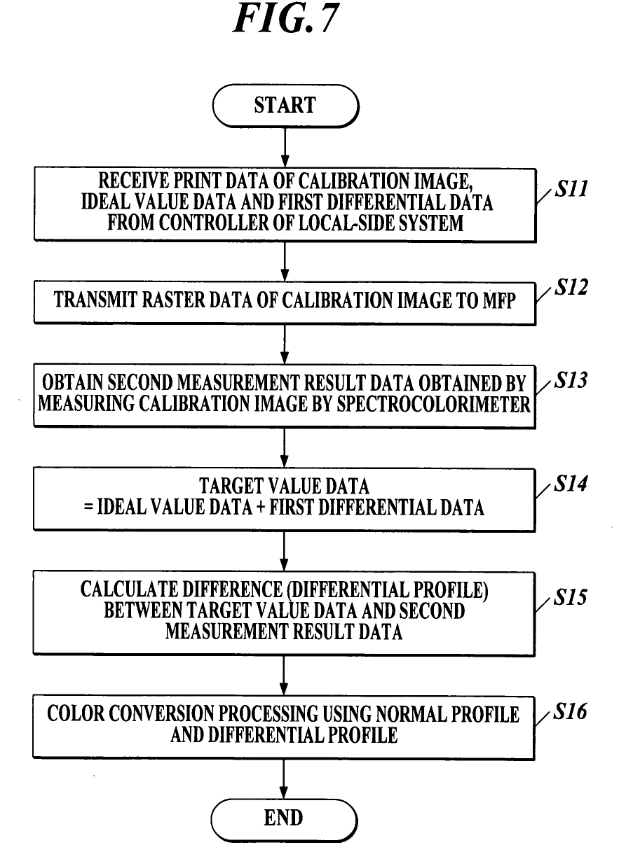

The controller 210 executes image processing containing color conversion processing on print data to generate raster data which can be printed by MFP 220. Particularly, in the first calibration processing (see FIG. 7), the controller 210 receives the print data of the calibration image, the ideal value data and the first differential data from the controller 110, and outputs the raster data based on the print data of the calibration image to MFP 220 to make MFP 220 print the calibration image.

MFP 220 carries out printing on a recording medium such as a sheet or the like on the basis of the raster data generated by the controller 210. Particularly, in the first calibration processing, MFP 220 prints the calibration image. Furthermore, MFP 220 has not only a printer function, but also a copying function, a scanner function and a FAX transmission/reception function.

The spectrocolorimeter 230 spectroscopically measures the color of each patch of the calibration image printed by MFP 220. Specifically, second measurement result data in which the color of each patch is represented by L*a*b* color specification system are obtained.

The controller 210 obtains the second measurement result data measured by the spectrocolorimeter 230. Then, the controller 210 adds the ideal value data and the first differential data received from the controller 110 to calculate target value data, and calculates second differential data (hereinafter referred to as “differential profile”) which is a difference between the calculated target value data and the second measurement result data. Furthermore, the controller 210 corrects the color conversion processing condition in the controller 210 on the basis of the differential profile.

Next, the construction of the controller 110 of the local-side system 100 will be described in detail.

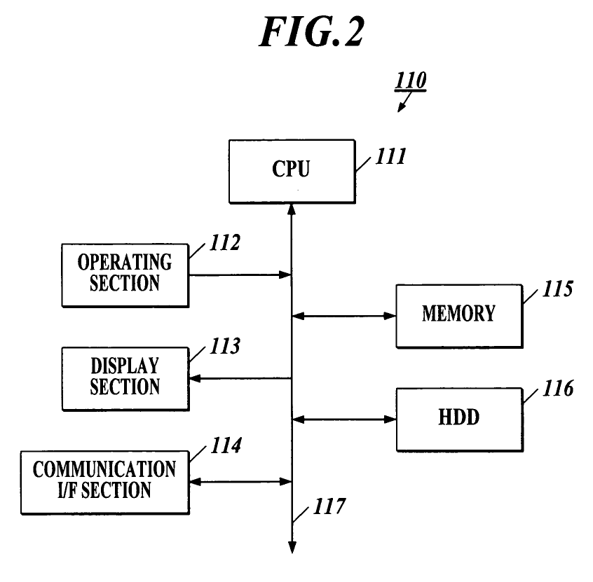

As shown in FIG. 2, the controller 110 is equipped with a CPU (Central Processing Unit) 111, an operating section 112, a display section 113, a communication I/F section 114, a memory 115, an HDD (Hard Disk Drive) 116, etc., and the respective sections 117 are connected to one another through a bus 117. The controller 110 is generally implemented by a workstation or PC (Personal Computer).

The CPU 111 governs and controls the processing operations of the respective sections of the controller 110. The CPU 111 reads out various kinds of processing programs stored in the HDD 116 in accordance with an instruction signal which is input from the operating section 112 and received by the operating signal or the communication I/F section 114 and develops them in the memory 115, and executes various kinds of processing in cooperation with the program concerned.

The operating section 112 is equipped with various kinds of operating keys, and when each key is pressed, a press signal is output to the CPU 111. Furthermore, the operating section 112 is equipped with a touch panel which is integrally formed on the surface of the display section 113, detects a touch position of a user's fingertip, a touch pen or the like on the touch panel, and outputs a position signal to the CPU 111.

The display section 113 is equipped with LCD (Liquid Crystal Display), and displays various kinds of operating screens and various kinds of processing results according to an instruction from the CPU 111.

The communication I/F section 114 transmits/receives data to/from external equipment. For example, the communication I/F section 114 receives print data which is instructed to be printed by an external PC. Furthermore, the communication I/F section 114 transmits raster data generated on the basis of the print data to MFP 120. Furthermore, the communication I/F section 114 receives the first measurement result data of the measured calibration image from the spectrocolorimeter 130. The communication I/F section 114 transmits the print data of the calibration image, the ideal value data and the first differential data to the controller 210.

The memory 115 is composed of RAM (Random Access Memory) or the like, and it forms a work area for temporarily storing various kinds of processing programs executed by the CPU 111 and data associated with these programs. For example, the memory 115 temporarily stores the print data received from an external PC.

The HDD 116 stores various kinds of processing programs for controlling the respective sections of the controller 110 by the CPU 111, information concerning the various kinds of processing, etc. For example, the print data of the calibration image and the ideal value data are stored in the HDD 115 in advance. The ideal value data are the ideal value of the color of each patch of the case where the calibration image is printed, represented by the machine independent color specification system which is independent from an apparatus (in this embodiment, the L*a*b* color specification system). Furthermore, a normal profile as data representing a standard characteristic concerning color of MFP 120 is stored in the HDD 116 in advance. The normal profile is a product-specific representative profile prepared under the development. It is normally mounted in the controller 110 at the shipping time of articles, and individual difference or variation based on environment is not reflected to the normal profile.

The CPU 111 executes image processing containing color conversion processing on the print data received from the external PC to generate raster data which can be printed by MFP 120. When the color conversion processing is executed, CMM (Color Management Module) installed in the image processing program is used. CMM is a module for converting print data to proper color data. The color conversion processing is executed by using a color data conversion lookup table (LUT) for converting RGB data (color specification system used for print data) to CMYK data (color specification system of color materials used in MFP 120), for example. The CPU 111 executes the color conversion processing of the print data by using the normal profile stored in the HDD 116.

Furthermore the CPU 111 reads out the print data of the calibration image stored in the HDD 16, and executes the image processing containing the color conversion processing on the print data of the calibration image to generate the raster data. Then, the CPU 111 transmits the generated raster data of the calibration image through the communication I/F section 114 to MFP 120, and allows MFP 120 to print the calibration image.

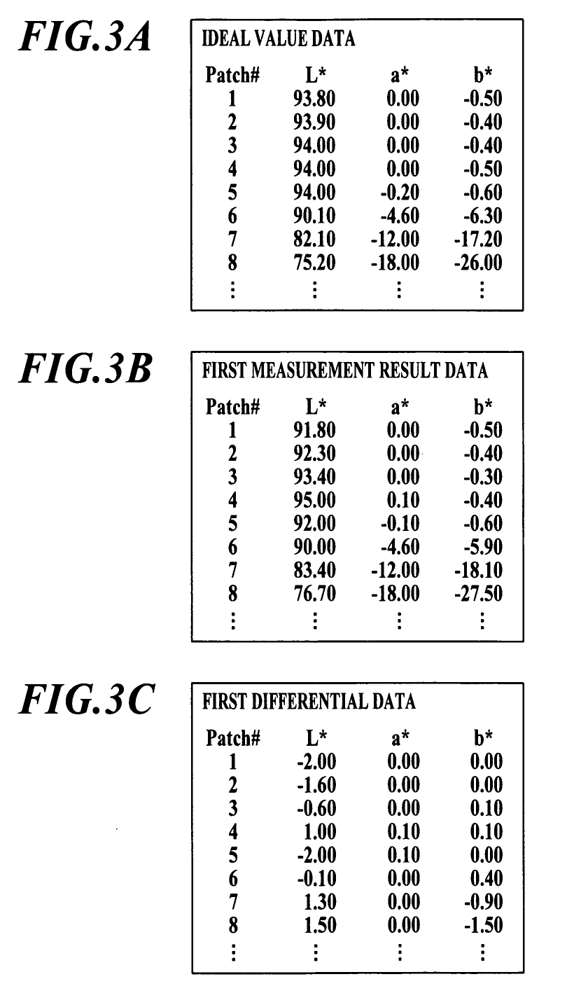

Furthermore, the CPU 111 obtains, through the communication I/F section 114, first measurement result data which are obtained by measuring the calibration image printed with the MFP 120 by the spectrocolorimeter 130 and are represented by the L*a*b* color specification system. Then, the CPU 111 reads out the ideal value data stored in the HDD 116, and calculates the first differential data which is a difference between the ideal value data and the first measurement result data. FIG. 3A shows an example of the ideal value data, FIG. 3B shows an example of the first measurement result data, and FIG. 3C shows the first differential data.

Furthermore, the CPU 111 transmits the print data of the calibration image, the ideal value data and the first differential data through the communication I/F section 114 to the controller 210.

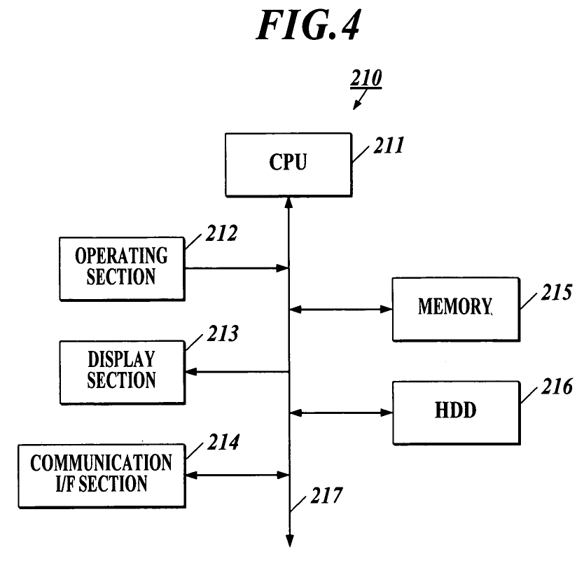

Next, the construction of the controller 210 of the remote-side system 200 will be described in detail with reference to FIG. 4.

As shown in FIG. 4, the controller 210 is equipped with the CPU 211, an operating section 212, a display section 213, a communication I/F section 214, a memory 215, the HDD 216, etc., and the respective sections are connected to one another through a bus 217. The controller 210 is generally implemented by a work station or PC.

The controller 210 has the same construction as the controller 110 shown in FIG. 2, and thus only different portions from the controller 110 will be described.

The communication I/F section 214 transmits/receives data to/from external equipment. For example, the communication I/F section 214 receives print-instructed print data from an external PC. Furthermore, the communication I/F section 214 transmits the raster data generated on the basis of the print data to MFP 220. Furthermore, the communication I/F section 214 receives the print data of the calibration image, the ideal value data and the first differential data from the controller 210. Furthermore, the communication I/F section 214 receives from the spectrocolorimeter 230 the second measurement result data obtained by measuring the calibration image.

The HDD 216 stores various kinds of processing programs for controlling the respective sections of the controller 210 by the CPU 211, information concerning various kinds of processing, etc. For example, a normal profile as data indicating a standard characteristic concerning color used in MFP 220 is stored in the HDD 216 in advance.

The CPU 211 executes the image processing containing the color conversion processing on the print data received from an external PC to generate raster data which can be printed by MFP 220. When the color conversion processing is executed, CMM installed in the image processing program is used. CMM executes the color conversion processing by using a color data conversion lookup table for conversion from RGB data (the color specification system used for print data) to CMYK data (the color specification system of color materials used in MFP 220), for example.

Furthermore, the CPU 211 temporarily stores into the memory 215 the print data of the calibration image, the ideal value data and the first differential data which are received from the controller 110 through the communication I/F section 214.

Still furthermore, the CPU 211 executes the image processing containing the color conversion processing on the print data of the calibration image received from the controller 110 to generate raster data. Then, the CPU 211 transmits the generated raster data of the calibration image through the communication I/F section 214 to MFP 220 to allow MFP 220 to print the calibration image.

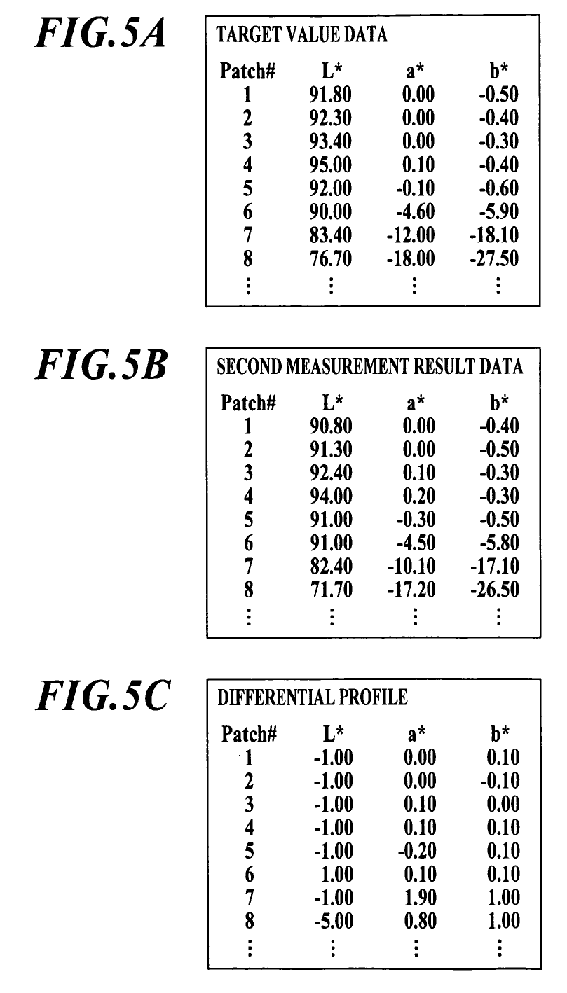

The CPU 211 obtains, through the communication I/F section 214, second measurement result data which are obtained by measuring the calibration image printed with the MFP 220 by the spectrocolorimeter 230 and are represented by the L*a*b* color specification system. Then, the CPU 211 reads out the ideal value data and the first differential data which are temporarily stored in the memory 215, and adds the ideal value data and the first differential data to calculate the target value data. Furthermore, the CPU 211 calculates the differential profile which is a difference between the target value data and the second measurement result data. FIG. 5A shows an example of the target value data, FIG. 5B shows an example of the second measurement result data and FIG. 5C shows an example of the differential profile.

The CPU 211 corrects the color conversion processing condition in the controller 210 on the basis of the differential profile. Specifically, the CPU 211 calibrates the lookup table used for the color conversion processing on the basis of the differential profile so that the color printed in the remote-side system 200 is matched with the color printed in the local-side system 100. That is, the execution of the color conversion processing of the print data by using the normal profile and the differential profile corresponds to the execution of the color conversion processing under the calibrated color conversion processing condition.

Next, the operation in the color calibration system 1 will be described.

The first reference data generating processing executed by the controller 110 of the local-side system 100 will be described with reference to FIG. 6.

First, the print data of the calibration image stored in the HDD 116 are read out by the CPU 111, and the image processing containing the color conversion processing is executed on the print data of the calibration image to generate raster data. Here, the color conversion processing is executed by using the normal profile. Subsequently, according to the control of the CPU 111, the raster data of the calibration image is transmitted to the MFP 120 by the communication I/F section 114 (step S1). In MFP 120, the calibrated image is printed on the recording medium.

Subsequently, the calibrated image printed by MFP 120 is measured by the spectrocolorimeter 130. Subsequently, the first measurement result data measured by the spectrocolorimeter 130 are obtained through the communication I/F section 114 by the CPU 111 (step S2). Then, the CPU 111 reads out the ideal value data stored in the HDD 116, and calculates the first differential data which is a difference between the ideal value data and the first measurement result data (step S3).

Subsequently, according to the control of the CPU 111, the communication I/F section 114 transmits the print data of the calibration image, the ideal value data and the first differential data to the controller 210 of the remote-side system 200 (step S4).

When printing is carried out in the local-side system 100, the CPU 111 executes the color conversion processing on the print data received from the external PC by using the normal profile (step S5). That is, in the local-side system 100, printing is carried out with the presents color reproduction characteristic, and the processing of matching the color with the ideal value is not executed.

Next, the first calibration processing executed by the controller 210 of the remote-side system will be described with reference to FIG. 7.

First, the print data of the calibration image, the ideal value data and the first differential data transmitted from the controller 110 of the local-side system 100 are received by the communication I/F section 214 (step S11), and the CPU 211 temporarily stores these data into the memory 215.

Subsequently, the print data of the calibration image stored in the memory 215 are read out by the CPU 211, and the image processing containing the color conversion processing is executed on the print data of the calibration image to generate raster data. Here, the color conversion processing is executed by using the normal profile. Subsequently, according to the control of the CPU 211, the communication I/F section 214 transmits the raster data of the calibration image to MFP 220 (step S12). In MFP 220, the calibration image is printed on the recording medium.

Subsequently, the calibration image printed by MFP 220 is measured by the spectrocolorimeter 230. Subsequently, the CPU 211 obtains the second measurement result data measured by the spectrocolorimeter 230 through the communication I/F section 214 (step S13). Then, the CPU 211 reads out the ideal value data and the first differential data which are temporarily stored in the memory 215, and adds the ideal value data and the first differential data to calculate the target value data (step S14). Subsequently, the CPU 211 calculates the differential profile which is a difference between the target value data and the second measurement result data (step S15), and stores the calculated differential profile into the HDD 216.

When printing is carried out in the remote-side system 200, the CPU 211 executes the color conversion processing on the print data received from the external PC by using the normal profile and the differential profile (step S16). That is, the color conversion processing is executed under the color data conversion condition (lookup fable) calibrated on the basis of the differential profile.

As described above, according to the color calibration system 1 according to the first embodiment, by transmitting the print data of the calibration image, the ideal value data and the first differential data from the controller 110 to the controller 210, the color reproduction characteristic in the local-side system 100 can be reproduced in the remote-side system 200. Accordingly, it is unnecessary to match the colors of both the printing systems with the standard color unlike the prior art, and the color reproduction characteristic of the local-side system 100 is not adjusted, but only the color reproduction characteristic of the remote-side system 200 is adjusted so that the color thereof is matched with the color of the local-side system 100. Therefore, among plural printing systems, the color reproduction characteristics of the printing systems can be easily matched with the color reproduction characteristic of one of the printing systems irrespective of use of the same or different color materials in the printing systems.

The first reference data generation processing and the first calibration processing may be executed when the system is started, may be executed every predetermined time or may be executed before a common printed material is output in the local-side system 100 and the remote-side system 200.

Furthermore, in the first embodiment, the print data of the calibration image, the ideal value data and the first differential data are transmitted from the local-side system 100 to the remote-side system 200. However, when the print data of the calibration image and the ideal value data are stored in both the controller 110 and the controller 210, only the first differential data may be transmitted from the controller 110 to the controller 210.

### Second Embodiment

Next, a second embodiment to which the present invention is applied will be described.

The color calibration system according to the second embodiment has the construction similar to the construction of the color calibration system 1 of the first embodiment. Therefore, the same constituent elements thereof are represented by the same reference numerals, and the illustration and description thereof are omitted. The discriminative construction and processing of the second embodiment will be described.

In the color calibration system 1 according to the first embodiment, the print data of the calibration image, the ideal value data and the first differential data (a difference between the ideal value data and the first measurement result data) are transmitted from the local-side system 100 to the remote-side system 200. However, in the color calibration system of the second embodiment, the print data of the calibration image and first measurement result data represented by a machine independent color specification system are transmitted from the local-side system 100 to the remote-side system 200.

First, the discriminative construction of the second embodiment with respect to the controller 110 of the local-side system 100 will be described.

The CPU 111 obtains, through the communication I/F section 114, first measurement result data, which are obtained by measuring the calibration image printed with the MFP 120 by the spectrocolorimeter 130 and are represented by the L*a*b* color specification system. The CPU 111 transmits the print data of the calibration image and the first measurement result data through the communication I/F section 114 to the controller 210.

The communication I/F section 114 transmits the print data of the calibration image and the first measurement result to the controller 210.

Next, the discriminative construction of the second embodiment with respect to the controller 210 of the remote-side system 200 will be described.

The communication I/F section 214 receives the print data of the calibration image and the first measurement result data from the controller 210.

The CPU 211 temporarily stores into the memory 215 the print data of the calibration image and the first measurement result data received from the controller 110 through the communication I/F section 214.

The CPU 211 obtains, through the communication I/F section 214, second measurement result data, which are obtained by measuring the calibration image printed with the MFP 220 by the spectrocolorimeter 230 and are represented by the L*a*b* color specification system. Then, the CPU 211 reads out the first measurement result data stored temporarily in the memory 215, and calculates the differential data between the first measurement result data and the second measurement result data (hereinafter referred to as “differential profile”).

The CPU 211 corrects the color conversion processing condition in the controller 210 on the basis of the differential profile. Specifically, the CPU 211 calibrates the lookup table used for the color conversion processing on the basis of the differential profile so that the color printed in the remote-side system 200 is matched with the color printed in the local side system 100. That is, the execution of the color conversion processing of the print data by using the normal profile and the differential profile corresponds to the execution of the color conversion processing under the calibrated color conversion processing condition.

Next, the operation of the color calibrating system according to the second embodiment will be described.

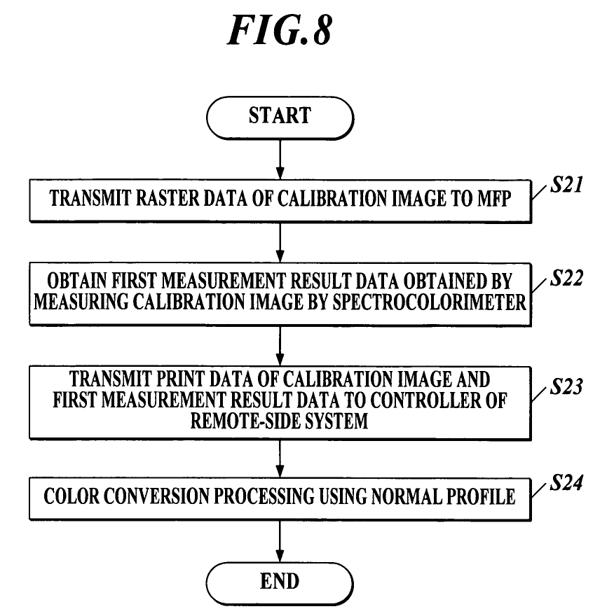

The second reference data generating processing executed by the controller 110 of the local-side system 100 will be described with reference to FIG. 8.

First, the CPU 111 reads out the print data of the calibration image stored in the HDD 116, and the image processing containing the color conversion processing is executed on the print data of the calibration image to generate raster data. Here, the color conversion processing is executed by using the normal profile. Subsequently, according to the control of the CPU 111, the communication I/F section 114 transmits the raster data of the calibration image to MFP 120 (step S21). In MFP 120, the calibration image is printed on a recording medium.

Subsequently, the calibration image printed by MFP 120 is measured by the spectrocolorimeter 130. Subsequently, the first measurement result data which are measured by the spectrocolorimeter 130 and represented by the L*a*b* color specification system are obtained through the communication I/F section 114 by the CPU 111 (step S22).

Subsequently, according to the control of the CPU 111, the communication I/F section 114 transmits the print data of the calibration image and the first measurement result data to the controller 210 of the remote-side system 200 (step S23).

When printing is carried out in the local-side system 100, the CPU 111 executes the color conversion processing on the print data received from the external PC by using the normal profile (step S24). That is, in the local-side system 100, printing is carried out with the current color reproduction characteristic and the processing of matching the color with the ideal value is not executed.

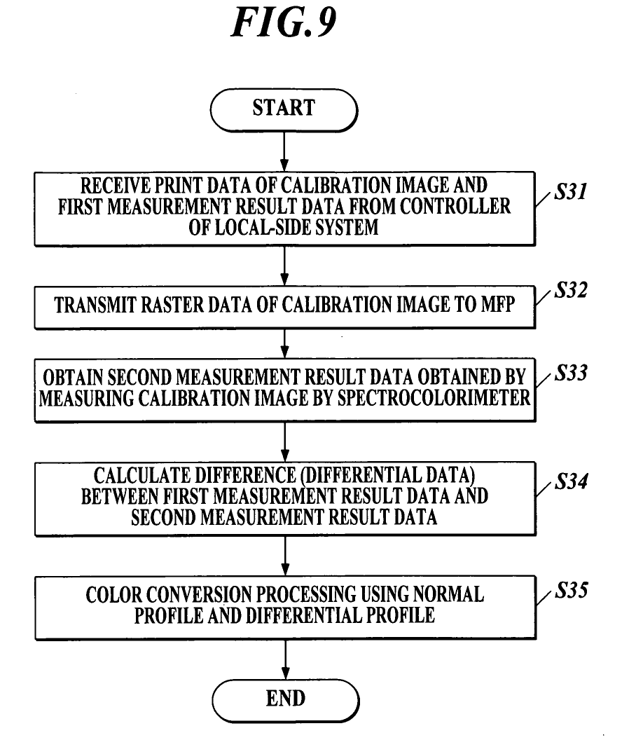

Next, the second calibration processing executed by the controller 210 of the remote-side system 200 will be described with reference to FIG. 9.

First, the print data of the calibration image and the first measurement result data which are transmitted from the controller 110 of the local-side system 100 are received through the communication I/F section 214 (step S31), and the CPU 211 temporarily stores these data into the memory 215.

Subsequently, the print data of the calibration image stored in the memory 215 are read out by the CPU 211, and the image processing containing the color conversion processing is executed on the print data of the calibration image to generate raster data. Here, the color conversion processing is executed by using the normal profile. Subsequently, according to the control of the CPU 211, the raster data of the calibration image are transmitted to MFP 220 through the communication I/F section 214 (step S32). In MFP 220, the calibration image is printed on a recording medium.

Subsequently, the calibration image printed by MFP 220 is measured by the spectrocolorimeter 230. Subsequently, the CPU 211 obtains the second measurement result data which is measured by the spectrocolorimeter 230 and represented by the L*a*b* color specification system through the communication I/F section 214 (step S33). The CPU 211 reads out the first measurement result data stored temporarily in the memory 215, calculates the differential profile which is a difference between the first measurement result data and the second measurement result data (step S34), and stores the calculated differential profile into the HDD 216.

When printing is carried out in the remote-side system 200, the CPU 211 executes the color conversion processing on the print data received from the external PC by using the normal profile and the differential profile (step S35). That is, the color conversion processing is executed under the color conversion processing condition (lookup table) calibrated on the basis of the differential profile.

As described above, according to the color calibration system of the second embodiment, by transmitting the print data of the calibration image and the first measurement result data from the controller 110 to the controller 210, the color reproduction characteristic in the local-side system 100 can be reproduced in the remote-side system 200. Accordingly, it is unnecessary to match the colors of both the printing systems with the standard color unlike the prior art, and the color reproduction characteristic of the local-side system 100 is not adjusted, but only the color reproduction characteristic of the remote-side system 200 is adjusted so that the color thereof is matched with the color of the local-side system 100. Therefore, color matching is easily established among plural printing systems irrespective of use of the same or different color materials in the printing systems.

The second reference data generation processing and the second calibration processing may be executed when the system is started, may be executed every predetermined time or may be executed before a common printed material is output in the local-side system 100 and the remote-side system 200.

Furthermore, in the second embodiment, the print data of the calibration image and the first measurement result data are transmitted from the local-side system 100 to the remote-side system 200. However, when the print data of the calibration image are stored in both the controller 110 and the controller 210 in advance, only the first measurement result data may be transmitted from the controller 110 to the controller 210.

Furthermore, the descriptions of the first and second embodiments are associated with examples of the color calibration system according to the present invention, and thus the present invention is not limited to these embodiments. With respect to the detailed construction and detailed operation of each part constituting the system, proper modifications may be made without departing from the subject matter of the present invention.

According to one aspect of the embodiments of the present invention, the color calibration system includes: a first printing system having a first image processing apparatus to execute image processing containing color conversion processing on print data, a first printing apparatus and a first calorimeter; and a second printing system having a second image processing apparatus to execute image processing containing color conversion processing on print data, a second printing apparatus and a second calorimeter, wherein the first printing system and the second printing system are connected to each other through a communication network, wherein the first image processing apparatus includes: a controller to control the first printing apparatus to print a calibration image on the basis of print data of a calibration image, to obtain first measurement result data that is obtained by measuring the calibration image printed with the first printing apparatus by the first colorimeter and represented by a machine independent color specification system, and to calculate first differential data which is a difference between the first measurement result data and ideal value data which is an ideal value of the color of the calibration image represented by the machine independent color specification system; and a transmitting section to transmit to the second image processing apparatus at least the first differential data out of the print data of the calibration image, the ideal value data and the first differential data, and wherein the second image processing apparatus includes: a receiving section to receive at least the first differential data out of the print data of the calibration image, the ideal value data and the first differential data from the first image processing apparatus; and a controller to control the second printing apparatus to print a calibration image on the basis of the print data of the calibration image, to obtain second measurement result data that is obtained by measuring the calibration image printed with the second printing apparatus by the second calorimeter and represented by the machine independent color specification system, to add the ideal value data and the first differential data to calculate target value data, to calculate second differential data which is a difference between the calculated target value data and the second measurement result data, and to calibrate a color conversion processing condition in the second image processing apparatus on the basis of the second differential data.

Preferably, the first image processing apparatus further comprises a storage section to store the print data of the calibration image and the ideal value data which is the ideal value of a color corresponding to the calibration image represented by the machine independent color specification system which is not dependent on an apparatus.

Moreover, preferably, the machine independent color specification system is an L*a*b* color specification system.

Moreover, preferably, the controller of the second image processing apparatus calibrates the color conversion processing condition by calibrating a color data conversion lookup table.

Moreover, preferably, the color data conversion lookup table is a lookup table to convert a color specification system used for print data to a color specification system of color materials used in the second printing apparatus.

According to one aspect of the embodiments of the present invention, the color calibration system includes: a first printing system having a first image processing apparatus to execute image processing containing color conversion processing on print data, a first printing apparatus and a first calorimeter; and a second printing system having a second image processing apparatus to execute image processing containing color conversion processing on print data, a second printing apparatus and a second colorimeter, wherein the first printing system and the second printing system are connected to each other through a communication network, wherein the first image processing apparatus includes: a controller to control the first printing apparatus to print a calibration image on the basis of print data of a calibration image, and to obtain first measurement result data that is obtained by measuring the calibration image printed with the first printing apparatus by the first colorimeter and represented by a machine independent color specification system; and a transmitting section to transmit to the second image processing apparatus at least the first measurement result data out of the print data of the calibration image and the first measurement result data, and wherein the second image processing apparatus includes: a receiving section to receive at least the first measurement result data out of the print data of the calibration image and the first measurement result data; and a controller to control the second printing apparatus to print a calibration image on the basis of the print data of the calibration image, to obtain second measurement result data that is obtained by measuring the calibration image printed with the second printing apparatus by the second colorimeter and represented by the machine independent color specification system, to calculate differential data which is a difference between the first measurement result data and the second measurement result data, and to calibrate a color conversion processing condition in the second image processing apparatus on the basis of the differential data.

Preferably, the first image processing apparatus further comprises a storage section to store the print data of the calibration image.

Moreover, preferably, the machine independent color specification system is an L*a*b* color specification system.

Moreover, preferably, the controller of the second image processing apparatus calibrates the color conversion processing condition by calibrating a color data conversion lookup table.

Moreover, preferably, the color data conversion lookup table is a lookup table for converting a color specification system used for print data to a color specification system of color materials used in the second printing apparatus.

Above description of the embodiment is an example of the invention, and the present invention is not limited to the embodiment. The detail composition and the detail operation of the image forming apparatus can be changed appropriately within the spirit of the invention.

What is claimed is:

1. A color calibration system comprising:
a first printing system having a first image processing apparatus to execute image processing containing color conversion processing on print data, a first printing apparatus and a first calorimeter; and
a second printing system having a second image processing apparatus to execute image processing containing color conversion processing on print data, a second printing apparatus and a second colorimeter,
wherein the first printing system and the second printing system are connected to each other through a communication network,
wherein the first image processing apparatus includes:
a controller to control the first printing apparatus to print a calibration image on the basis of print data of a calibration image, to obtain first measurement result data that is obtained by measuring the calibration image printed with the first printing apparatus by the first calorimeter and represented by a machine independent color specification system, and to calculate first differential data which is a difference between the first measurement result data and ideal value data which is an ideal value of the color of the calibration image represented by the machine independent color specification system; and
a transmitting section to transmit to the second image processing apparatus at least the first differential data out of the print data of the calibration image, the ideal value data and the first differential data, and
wherein the second image processing apparatus includes:
a receiving section to receive at least the first differential data out of the print data of the calibration image, the ideal value data and the first differential data from the first image processing apparatus; and
a controller to control the second printing apparatus to print a calibration image on the basis of the print data of the calibration image, to obtain second measurement result data that is obtained by measuring the calibration image printed with the second printing apparatus by the second colorimeter and represented by the machine independent color specification system, to add the ideal value data and the first differential data to calculate target value data, to calculate second differential data which is a difference between the calculated target value data and the second measurement result data, and to calibrate a color conversion processing condition in the second image processing apparatus on the basis of the second differential data.

2. The color calibration system of claim 1, wherein the first image processing apparatus further comprises a storage section to store the print data of the calibration image and the ideal value data which is the ideal value of a color corresponding to the calibration image represented by the machine independent color specification system.

3. The color calibration system of claim 1, wherein the machine independent color specification system is an L*a*b* color specification system.

4. The color calibration system of claim 1, wherein the controller of the second image processing apparatus calibrates the color conversion processing condition by calibrating a color data conversion lookup table.

5. The color calibration system of claim 4, wherein the color data conversion lookup table is a lookup table to convert a color specification system used for print data to a color specification system of color materials used in the second printing apparatus.

6. A color calibration system comprising:
a first printing system having a first image processing apparatus to execute image processing containing color conversion processing on print data, a first printing apparatus and a first calorimeter; and
a second printing system having a second image processing apparatus to execute image processing containing color conversion processing on print data, a second printing apparatus and a second colorimeter,
wherein the first printing system and the second printing system are connected to each other through a communication network,
wherein the first image processing apparatus includes:
a controller to control the first printing apparatus to print a calibration image on the basis of print data of a calibration image, and to obtain first measurement result data that is obtained by measuring the calibration image printed with the first printing apparatus by the first colorimeter and represented by a machine independent color specification system; and
a transmitting section to transmit to the second image processing apparatus at least the first measurement result data out of the print data of the calibration image and the first measurement result data, and
wherein the second image processing apparatus includes:
a receiving section to receive at least the first measurement result data out of the print data of the calibration image and the first measurement result data; and
a controller to control the second printing apparatus to print a calibration image on the basis of the print data of the calibration image, to obtain second measurement result data that is obtained by measuring the calibration image printed with the second printing apparatus by the second colorimeter and represented by the machine independent color specification system, to calculate differential data which is a difference between the first measurement result data and the second measurement result data, and to calibrate a color conversion processing condition in the second image processing apparatus on the basis of the differential data.

7. The color calibrating system of claim 6, wherein the first image processing apparatus further comprises a storage section to store the print data of the calibration image.

8. The color calibration system of claim 6, wherein the machine independent color specification system is an L*a*b* color specification system.

9. The color calibration system of claim 6, wherein the controller of the second image processing apparatus calibrates the color conversion processing condition by calibrating a color data conversion lookup table.

10. The color calibration system of claim 9, wherein the color data conversion lookup table is a lookup table for converting a color specification system used for print data to a color specification system of color materials used in the second printing apparatus.
